(19) United States
(12) Patent Application Publication
(10) Pub. No.: US 2016/0256017 A1
(43) Pub. Date: Sep. 8, 2016

(54) PERSONAL CLEANSING AND FLUID APPLICATION APPARATUS

(71) Applicant: Janitha Jackson, Milwaukee, WI (US)

(72) Inventor: Janitha Jackson, Milwaukee, WI (US)

(21) Appl. No.: 15/146,488

(22) Filed: May 4, 2016

Related U.S. Application Data
(60) Provisional application No. 62/127,975, filed on Mar. 4, 2015.

(51) Int. Cl. A47K 7/04; A47K 7/02; A46B 13/02; B25G 1/10; A46B 5/02; B25G 3/38

(52) U.S. Cl. CPC A47K 7/04; A46B 5/026; B25G 3/38; A46B 13/02; B25G 1/102; A47K 7/028; A46B 2200/1006

(57) ABSTRACT

A motorized rotating brush cleansing apparatus having an angularly adjustable handle and replaceable rotating pads which enable cleansing and treatment of a user's skin. The apparatus is intended to be especially helpful in reaching difficult to reach surfaces. The apparatus may also be utilized to apply topical lotions and creams.

### RELATED APPLICATIONS

The present application claims the benefit of provisional patent application Ser. No. 62/127,975 filed Feb. 4, 2015 which application is incorporated herein by reference.

### BACKGROUND OF THE INVENTION

1. Field of the Invention

The present invention relates to personal cleansing and fluid application apparatus, and more specifically to manual articulating rotary brush type elements with replaceable pads or heads.

2. Background Information

Brushes, with or without handles, and having bristles affixed to a back have been used for bathing and washing for a long time. Yet the common brushes have disadvantages. For example, it is sometimes necessary to make vigorous scrubbing movements to properly cleanse one's body. For most people, perhaps, this is not a problem, but for youngsters, the elderly, the infirm and very obese or corpulent people, such scrubbing may be difficult or impossible. One solution generally addressing the scrubbing deficiencies of the prior art, rather than improving the access of the prior art brushes, has been personal cleansing and fluid application apparatus in the form of rotary brushes.

For example U.S. Pat. No. 4,008,503 discloses a driven rotary brush which is mounted on an adjustable plate, and the adjustable plate is mounted through rails and runners to a wall plate. The wall plate has quick mounting devices such as suction cups for quick attachment. The rails and runners provide easy vertical height adjustment. The brush has a central member functioning as a sprayer that is easily connected through flexible tubing to the supply pipe for the shower spray head.

U.S. Pat. No. 4,008,503 discloses a rotary washing brush device in which a hydro motor in the housing is coupled to the brush whereby a flow of water through the ducts rotates the hydro motor and thereby rotates the brush.

U.S. Design Pat. D295,696 discloses a hand shower and massage brush.

U.S. Pat. No. 4,841,590 discloses a water-powered rotating brush device for use in a shower, having an elongated handle portion embodying a supply channel and a return channel, a flexible supply and return hose-pair connectable to the lower end of the handle, and a head portion which rotatably mounts a pair of eccentrically located gear rotors with the larger of the rotors having more teeth than the smaller, the rotors arranged so as to be positively displaced into rotary action by the flow there through of water under pressure.

U.S. Pat. No. 5,528,792 discloses a (non-rotating) shower brush with a handle at one end and a group of bristles located upon one face at the other end. This patent attempts to improve the access of prior art brushes and provides an axial pivot medial to two ninety degree bends taken with respect to the longitudinal axis of the shank. U-shaped and a S-shaped configurations are thus enabled, each being obtained from the other by rotation of one shank portion relative to the other through one hundred eighty degrees in either direction about the axial pivot. Each configuration may be secured to prevent accidental rotation and the pivot maintains the rotatable disposition of one shank portion in relation to the other. A relatively large hand grip, preferably having a resilient exterior, facilitates comfortable gripping. The U-shaped configuration is intended to facilitate scrubbing of one's back while a shower or bath utilizing a reciprocating motion of the hand gripping the handle frontally. The S-shaped configuration is intended to facilitate scrubbing of one's lower extremities in a shower or bath without bending of one's torso. Use of tubular plastic members with a pivot effected by the insertion of a reduced exterior diameter of one shank end into an open end of the other shank permits inexpensive, durable and water resistant construction.

U.S. Pat. No. 7,665,422 discloses hand held self cleaning rotary brush with means for accumulating collected hair for disposal, which is primarily designed for use with pets.

U.S. Pat. No. 8,020,242 discloses a “human torso scrubbing apparatus”. This patent attempts to improve the access of prior art brushes and provides a scrubbing apparatus including an elongated handle having a grasping portion toward one end thereof and a scrubbing element is secured to a second end of the handle. The grasping portion of the handle is offset at an angle ranging between about 75 and about 115 degrees relative to a portion of the handle extending from the scrubbing element so as to facilitate scrubbing of a human's back while the angular offset of said grasping portion allows said apparatus to freely hang when not in use.

It is the object of the present invention to address the deficiencies of the prior art and provide a highly effective, low-cost, easy to use personal cleansing and fluid application apparatus.

### SUMMARY OF THE INVENTION

The present invention provides a personal cleansing apparatus comprising a handle assembly having a proximal grip portion configured to be gripped by the user and a neck portion coupled together by a pivot mechanism and configured to pivot the grip portion between at least a stored position and two distinct operative positions; a head assembly coupled to a distal end of the neck portion opposite the pivot mechanism; a motor within the head assembly; and at least one rotating pad having a user engaging pad surface removably coupled to the head assembly and configured to be rotationally powered by the motor.

The advantages and features of the present invention will become better understood with reference to the following detailed description of the preferred embodiments and claims taken in conjunction with the accompanying drawings, in which like elements are identified with like reference numerals.

### BRIEF DESCRIPTION OF THE DRAWINGS

In the figures:

FIG. 1 is a perspective view of a personal cleansing and fluid application apparatus according to one preferred embodiment of the present invention;

FIG. 2 is a partially exploded perspective view of the apparatus of FIG. 1; and,

FIG. 3 is a side elevation view of the apparatus of FIG. 1 depicting manipulation of a handle assembly portion to distinct operative positions.

### DESCRIPTION OF THE PREFERRED EMBODIMENTS

It is noted that, as used in this specification and the appended claims, the singular forms “a,” “an,” and “the” include plural referents unless expressly and unequivocally limited to one referent. For the purposes of this specification, unless otherwise indicated, all numbers expressing parameters used in the specification and claims are to be understood as being modified in all instances by the term “about.” The terms “about” or “approximate” or similar terms within this application will generally mean within 10% unless otherwise noted. Accordingly, unless indicated to the contrary, the numerical parameters set forth in the following specification and attached claims are approximations that may vary depending upon the desired properties sought to be obtained by the present personal cleansing and fluid application apparatus 10. The various embodiments and examples of the personal cleansing and fluid application apparatus 10 as presented herein are understood to be illustrative of the present invention and not restrictive thereof and are non-limiting with respect to the scope of the invention.

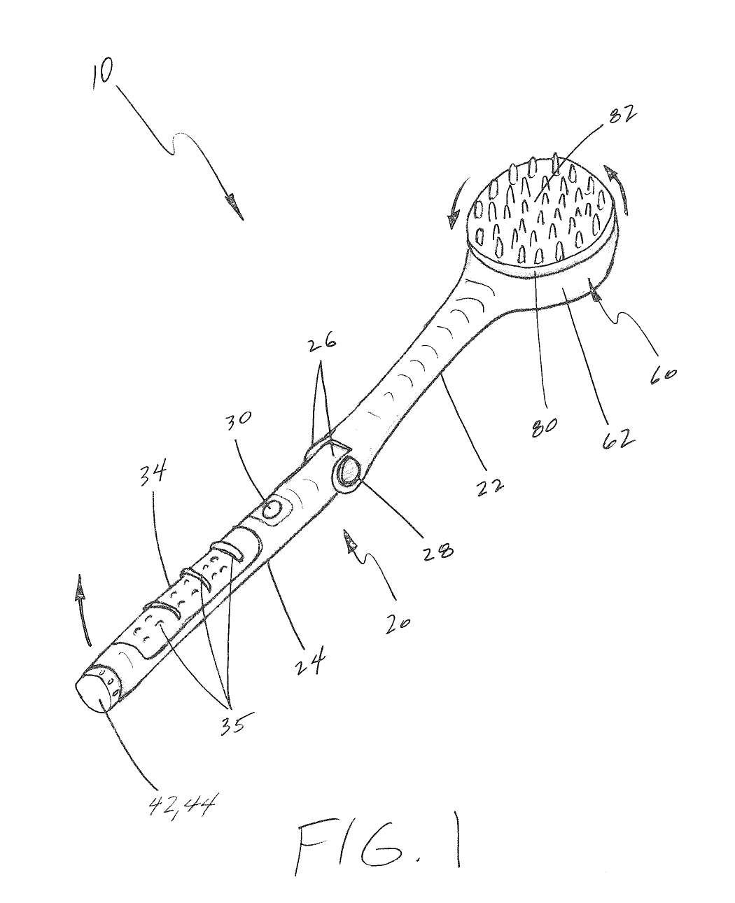

The best mode for carrying out the invention is presented in terms of its preferred embodiment, herein depicted within FIGS. 1 through 3. However, the invention is not limited to the described embodiment of the personal cleansing and fluid application apparatus 10, and a person skilled in the art will appreciate that many other embodiments of the personal cleansing and fluid application apparatus 10 are possible without deviating from the basic concept of the personal cleansing and fluid application apparatus 10 and that any such work around will also fall under scope of this invention. It is envisioned that other styles and configurations of the personal cleansing and fluid application apparatus 10 can be easily incorporated into the teachings of the present invention, and only one particular configuration shall be shown and described for purposes of clarity and disclosure and not by way of limitation of scope.

The present invention describes a personal cleansing and fluid application apparatus (herein described as the “apparatus”) 10, which provides a motorized brush (or brush like) device having features which enable cleansing of, and fluid application to a user's skin surfaces. The apparatus 10 is intended to be especially helpful in accessing difficult to reach rear surfaces.

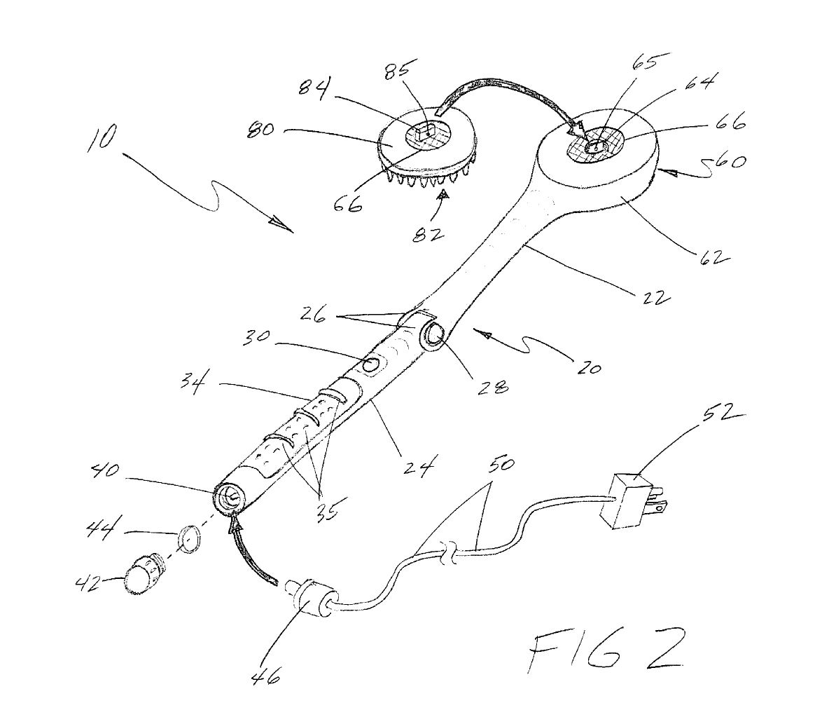

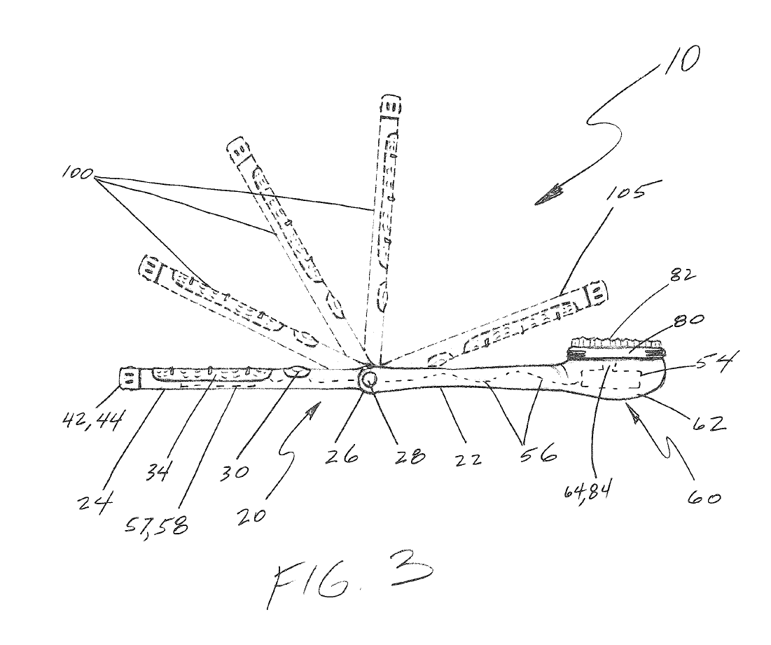

Referring now to FIG. 1, a perspective view of the apparatus 10, according to the preferred embodiment of the present invention, is shown. The apparatus 10 provides major portions including a handle assembly 20 and a head assembly 60. The handle assembly 20 further includes a neck portion or section 22 and a grip portion or section 24 being affixed to each other by an intermediately located pivot mechanism 26. The partially hollow handle assembly 20 also provides a housing for internal electrical and electronic portions including a variable-speed button 30, wiring 56, a battery 57, and a battery compartment 58 (see FIGS. 2 and 3).

The head assembly 60 provides interchangeable rotating pads 80 having different pad surfaces 82. The pad surfaces may be in the form of bristle to form brush elements or other structures for scrubbing and cleaning as discussed below. The head assembly 60 is powered by a battery 57 and an internal motor 54, and controlled by a variable-speed button 30 located upon the handle assembly 20.

It is envisioned that the handle assembly 20 and head assembly 60 portions of the apparatus 10 would be made using resilient plastic and rubber materials, would provide a waterproof construction, and be made available for purchase in a variety of decorative colors and patterns.

Referring now to FIG. 2, a partially exploded view of the apparatus 10, according to the preferred embodiment of the present invention, is shown. The head assembly portion 60 of the apparatus 10 provides removable attachment of a plurality of pads 80 intended for the purpose of cleansing, exfoliating, lotion application, and the like. The head assembly 60 provides a mechanism to retain the pad 80 via respective locking socket 64 and locking post 84 features. The locking socket 64 and locking post 84 portions provide respective rectangular male and female interlocking features which provide a mechanical slip-fit when inserted, thereby providing a non-rotating connection between the head assembly 60 and the pad 80. Furthermore, the locking socket 64 and locking post 84 include respective ball 64 and detent 85 portions along corresponding side surfaces which provide a secure temporary spring-loaded connection there between.

It is envisioned that the apparatus 10 would be made available for purchase having a desired number of pads 80 having respective pad surfaces 82 which perform various cleansing and skincare functions based upon a user's preferences. Each pad 80 includes a disc-shaped semi-rigid planar pad frame 81 having an outer pad surface 82. The pad surfaces 82 would be provide textures and pliable materials such as, but not limited to: terry cloth, sponge, Luffa, brushes, and the like, being suitable to perform cleansing, exfoliation, massaging, and the like.

Additionally, it is envisioned that the apparatus 10 would provide an effective means to distribute various skincare lotions and creams upon hard to reach areas of a user's body. Application of these fluids would be accomplished by manually applying a desired fluid to a suitable pad surface 82 capable of retaining the fluid for subsequent distribution upon the user's skin surfaces, such as a sponge.

The apparatus 10 is powered by at least one (1) internal rechargeable battery 57 located within the battery compartment portion 58 of the grip section 24. The battery 57 is to utilize current battery technology and is to be charged via attachment of an AC/DC charging power cord 50. The grip section 24 also includes a removable cap 42 being threadingly affixed to an end portion of the grip section 24. The cap 42 further includes an annular “O”-ring 44 to provide effective waterproofing of a male connector 40 located behind the cap 42. During recharging, the male connector 40 is engaged by a female connector portion 46 of the power cord 50. The power cord 50 also includes an integral pronged transformer plug portion 52 at an opposite end which provides normal connection to a household 110-volt duplex outlet.

Referring now to FIG. 3, a side view of the apparatus 10 depicting manipulation of a handle assembly 20 portion, according to a preferred embodiment of the present invention, is disclosed. The aforementioned pivot mechanism 26 is a single-axis hinging mechanism located between the neck section 22 and the grip section 24. The pivot mechanism 26 provides a mechanism to rotate the sections 22, 24 at least one-hundred eighty (180°) degrees relative to each other. The pivot mechanism 26 also secures the sections 22, 24 at a plurality of relative angles via a lock button portion 28. The lock button 28 functions as an axle member and a spring-loaded sliding spool mechanism which when released, mechanically retains the sections 22, 24 at their current relative position. The handle assembly 20 is illustrated here depicting a plurality of deployed handle angles 100 and a stowed handle position 105.

The apparatus 10 includes a variable-speed button 30 and an electric motor 54 to rotate the pad 80. Electrical power from the battery 57 is routed via wiring 56 within the hollow handle assembly 20 through the variable-speed button 30 and on to the motor 54. The motor 54 is to be of a variable-speed direct current (DC) type unit, and is located within an integral motor housing section 62 of the head assembly 60. The motor housing section 62 is located immediately subjacent to, and in mechanical communication with the previously described locking socket portion 64 of the head assembly 60. The motor 54 is envisioned to be a miniature pancake-type device which receives electrical current from the variable-speed button 30. A preferred embodiment of the variable-speed button 30 provides integrated circuitry capable of regulating and conducting an incrementally increasing voltage level to the motor 54 as the button 30 is pressed in a repetitive manner. Pressing the variable-speed button 30 results in corresponding rotational speeds of the motor 54 and pad 80 portions, providing for example, “slow”, “medium”, “fast”, and “off” selections.

The grip section 24 of the handle assembly 20 includes a “snap-in” battery compartment cover 34 having a high-friction gripping surface 35 along an outer surface portion, envisioned being made of rubber, latex, or soft plastic, and having a textured surface. Removal of the battery compartment cover 34 provides access to the rechargeable battery 57 within the grip section 24.

It is envisioned that other styles and configurations of the present invention can be easily incorporated into the teachings of the present invention, and only one particular configuration shall be shown and described for purposes of clarity and disclosure and not by way of limitation of scope.

### Operation of the Preferred Embodiment

The preferred embodiment of the apparatus 10 of the present invention can be utilized by the common user in a simple and effortless manner with little or no training. After initial purchase or acquisition of the apparatus 10, it would be configured as indicated in FIGS. 1 through 3.

The method of configuring and utilizing the apparatus 10 may be achieved by performing the following steps: procuring a model of the apparatus 10 having a desired external appearance; loading at least one (1) rechargeable battery 57 into the battery compartment 58 by removing the battery compartment cover 34; inserting the battery 57; replacing the battery compartment cover 34; removing the cap 42; inserting the female connector portion 46 of the power cord 50 onto the male connector 40; plugging the transformer plug 52 into a household duplex outlet for a period of time to charge the battery 57; removing the power cord 50 from the apparatus 10 and the duplex outlet; replacing the cap 42; selecting a pad 80 having a desired pad surface 82 suitable for an intended skin treatment process such as cleansing, exfoliating, massaging, and the like; installing the pad 80 upon the head assembly 60 by engaging respective locking post 84 and locking socket 64 portions until detecting a “click” as the detent 84 and ball 64 portions interlock to secure the pad 80 to the head assembly 60; adjusting a relative angle of the neck section 22 and grip section 24 portions of the handle assembly 20 by pressing the lock button 28; rotating the grip section 24 upward or downward until obtaining a desired deployed handle angle 100 based upon an intended usage; releasing the lock button 28 to retain the desired deployed handle angle 100 of the handle assembly 20; activating the rotation of the motor 54 and pad 80 portions by pressing the variable-speed button 30 in a repetitive manner until obtaining a desired speed of rotation of the pad 80; grasping the grip section 24 of the handle assembly 20 upon the textured battery compartment cover portion 34; manipulating the apparatus 10 across desired areas of a user's bodice; utilizing the effect of the rotating pad 80 for a period of time upon skin surfaces as needed; halting the rotation of the pad 80 by repeatedly pressing the variable-speed button 30 until the motor 54 and pad 80 stop rotating; installing a different pad 80 in like manner to perform additional skin treatments as needed; preparing the apparatus 10 for storage until needed again by pressing the lock button 28 and rotating the grip section 24 upward to the stowed handle position 105; and, benefiting from a versatile and effective skin treatment system, afforded a user of the present invention 10.

The method of utilizing the apparatus 10 to apply lotions and creams to a user's skin may be achieved by performing the following steps: selecting a desired pad 80 having a pad surface 82 suitable for retaining a lotion or cream; installing the pad 80 upon the head assembly 60 as described above; adjusting and selecting a desired deployed handle angle 100 based upon an intended application area, as described above; applying a desired quantity of lotion or cream upon the pad surface 82; placing the pad 80 gently upon an area of a user's bodice to be treated; distributing the lotion or cream upon the skin by activating the rotation of the motor 54 and pad 80 for a period of time using the variable-speed button 30, as described above; halting the rotation of the pad 80 by repeatedly pressing the variable-speed button 30 until the motor 54 and pad 80 stop rotating; and, replenishing and repeating the application of the lotion or cream as needed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A personal cleansing apparatus comprising:
a handle assembly having a proximal grip portion configured to be gripped by the user and a neck portion coupled together by a pivot mechanism and configured to pivot the grip portion between at least a stored position and two distinct operative positions;
a head assembly coupled to a distal end of the neck portion opposite the pivot mechanism;
a motor within the head assembly;
at least one rotating pad having a user engaging pad surface removably coupled to the head assembly and configured to be rotationally powered by the motor.

2. The apparatus of claim 1 further including a button on the handle assembly for controlling the operation of the motor.

3. The apparatus of claim 2 wherein the motor is a variable speed motor and the user can select variable speeds through the button.

4. The apparatus of claim 3 wherein the button is on the grip portion.

5. The apparatus of claim 1 wherein a mechanism to retain the pad to the head via respective locking socket and locking post features on the respective pad and head assembly which provide a mechanical slip-fit when inserted, thereby providing a non-rotating connection between the head assembly and the pad.

6. The apparatus of claim 5 wherein the locking socket and locking post include respective ball and detent portions along corresponding side surfaces which provide a secure temporary spring-loaded connection there between.

7. The apparatus of claim 1 wherein the pad surface is formed of one of terry cloth, sponge, Luffa, brushes and is suitable to perform cleansing, exfoliation, or massaging.

8. The apparatus of claim 1 wherein the motor is a variable speed electric motor.

9. The apparatus of claim 8 further including batteries within the handle assembly for powering the motor.

10. A personal cleansing and fluid application apparatus comprising:
a handle assembly having a proximal grip portion configured to be gripped by the user and a neck portion coupled together by a pivot mechanism and configured to pivot the grip portion between at least a stored position and a distinct operative position;
a head assembly coupled to a distal end of the neck portion opposite the pivot mechanism;
a motor within the head assembly;
at least one rotating pad having a user engaging pad surface removably coupled to the head assembly and configured to be rotationally powered by the motor, wherein each pad is configured to hold a apply lotions and creams and other fluids to the skin of the user.

11. A hand held rotating pad apparatus comprising:
a handle assembly having a proximal grip portion configured to be gripped by the user and a neck portion coupled together by a pivot mechanism and configured to pivot the grip portion between at least a stored position and two distinct operative positions;
a head assembly coupled to a distal end of the neck portion opposite the pivot mechanism;
a motor within the head assembly;
at least one rotating pad having a user engaging pad surface removably coupled via a mechanical slip fit connection to the head assembly and configured to be rotationally powered by the motor.

12. The apparatus of claim 11 further including a button on the handle assembly for controlling the operation of the motor.

13. The apparatus of claim 12 wherein the motor is a variable speed motor and the user can select variable speeds through the button.

14. The apparatus of claim 13 wherein the button is on the grip portion.

15. The apparatus of claim 11 wherein a mechanism to retain the pad to the head via respective locking socket and locking post features on the respective pad and head assembly which provide the mechanical slip-fit when inserted, thereby providing a non-rotating connection between the head assembly and the pad.

16. The apparatus of claim 15 wherein the locking socket and locking post include respective ball and detent portions along corresponding side surfaces which provide a secure temporary spring-loaded connection there between.

17. The apparatus of claim 11 wherein the pad surface is formed of one of terry cloth, sponge, Luffa, brushes and is suitable to perform cleansing, exfoliation, or massaging.

18. The apparatus of claim 11 wherein the motor is a variable speed electric motor.

19. The apparatus of claim 18 further including batteries within the handle assembly for powering the motor.

20. The apparatus of claim 19 further including a button on the handle assembly for controlling the operation of the motor and gripping elements on the grip portion.
